(19) United States
(12) Patent Application Publication
(10) Pub. No.: US 2020/0236225 A1
(43) Pub. Date: Jul. 23, 2020

(54) DIAGNOSTIC APPARATUS, IMAGE DIAGNOSTIC METHOD, AND NON-TRANSITORY STORAGE MEDIUM

(71) Applicants: Toshiyuki HONGO, Kanagawa (JP); Takashi ENAMI, Kanagawa (JP); Satoru KOMATSUBARA, Kanagawa (JP); Ryu HASEGAWA, Kanagawa (JP); Hiroaki NAGATA, Kanagawa (JP)

(72) Inventors: Toshiyuki HONGO, Kanagawa (JP); Takashi ENAMI, Kanagawa (JP); Satoru KOMATSUBARA, Kanagawa (JP); Ryu HASEGAWA, Kanagawa (JP); Hiroaki NAGATA, Kanagawa (JP)

(21) Appl. No.: 16/745,441

(22) Filed: Jan. 17, 2020

(30) Foreign Application Priority Data
Jan. 23, 2019 (JP) 2019-009312

(51) Int. Cl. H04N 1/00

(52) U.S. Cl. CPC H04N 1/00045; H04N 1/00031; H04N 1/00029

(57) ABSTRACT

A diagnostic apparatus includes a recording device, an acquisition device, and processing circuitry. The acquisition device acquires first and second diagnostic target data obtained in a manner that an image forming device forms a test pattern on each of a first medium and a second smaller medium with the first medium having a long side in agreement with that of the second medium in a conveying direction and an image reading device reads the first medium and reads the second medium rotated such that the long side of the second medium is different in direction from that of the first medium. The circuitry detects an abnormal area and diagnoses an abnormality factor, with the pattern, the first and second data, and third diagnostic target data obtained by rotating the second data such that the long side of the second medium is identical in direction to that of the first medium.

### CROSS-REFERENCE TO RELATED APPLICATIONS

This patent application is based on and claims priority pursuant to 35 U.S.C. § 119(a) to Japanese Patent Application No. 2019-009312, filed on Jan. 23, 2019, in the Japan Patent Office, the entire disclosure of which is hereby incorporated by reference herein.

### BACKGROUND

### Technical Field

The present disclosure relates to a diagnostic apparatus, an image diagnostic method, and a non-transitory storage medium.

### Discussion of the Background Art

In order to inspect abnormality in an image formation system of an image forming apparatus, a technique has been known in which a test pattern is printed, read with a scanner, and converted into data to diagnose presence or absence of abnormality inside a machine or outside a system. In the diagnosis, when it is assumed that two abnormalities due to a printer factor and a scanner factor overlap and appear on an image read with the scanner, failure in judgement between those abnormalities has resulted in an erroneous decision.

For example, for an object of obtaining a detection method enabling discrimination of the cause of an image defect included in a read image, there has been known a technique of determining the cause of an image defect on the basis of the direction of the read image defect.

### SUMMARY

In an aspect of the present disclosure, a diagnostic apparatus diagnoses an image forming device that forms an image on a recording medium conveyed in a conveying direction and an image reading device that reads the image formed on the recording medium. The diagnostic apparatus includes a recording device, an acquisition device, and processing circuitry. The recording device records a test pattern. The acquisition device acquires first diagnostic target data and second diagnostic target data, the first diagnostic target data and the second diagnostic target data being obtained in a manner that the image forming device forms the test pattern on each of a first recording medium and a second recording medium smaller in size than the first recording medium with the first recording medium having a long side in agreement with a long side of the second recording medium in the conveying direction and the image reading device reads the first recording medium and reads the second recording medium rotated such that the long side of the second recording medium is different in direction from the long side of the first recording medium. The processing circuitry detects an abnormal area and diagnoses an abnormality factor, with the test pattern, the first diagnostic target data, the second diagnostic target data, and third diagnostic target data obtained by rotating the second diagnostic target data such that the long side of the second recording medium is identical in direction to the long side of the first recording medium.

In another aspect of the present disclosure, an image diagnostic method includes retaining a test pattern, forming, with an image forming device, the test pattern on each of a first recording medium and a second recording medium smaller in size than the first recording medium with the first recording medium having a long side in agreement with a long side of the second recording medium in a conveying direction, acquiring first diagnostic target data read by an image reading device from the first recording medium on which the test pattern is formed and second diagnostic target data read by the image reading device from the second recording medium on which the test pattern is formed, the second recording medium being rotated such that a long side of the second recording medium is different in direction from a long side of the first recording medium, and diagnosing an abnormal factor by detecting an abnormal area, with the test pattern, the first diagnostic target data, the second diagnostic target data, and third diagnostic target data obtained by rotating the second diagnostic target data such that the long side of the second recording medium is identical in direction to the long side of the first recording medium.

In still another aspect of the present disclosure, a non-transitory storage medium stores program code for causing a diagnostic apparatus that diagnoses an image forming device that forms an image on a recording medium conveyed in a conveying direction and an image reading device that reads the image formed on the recording medium to execute recording a test pattern, acquiring first diagnostic target data and second diagnostic target data, the first diagnostic target data and the second diagnostic target data being obtained in a manner that the image forming device forms the test pattern on each of a first recording medium and a second recording medium smaller in size than the first recording medium with the first recording medium having a long side in agreement with a long side of the second recording medium in the conveying direction and the image reading device reads the first recording medium and reads the second recording medium rotated such that the long side of the second recording medium is different in direction from the long side of the first recording medium, and diagnosing an abnormality factor by detecting an abnormal area with the test pattern, the first diagnostic target data, the second diagnostic target data, and third diagnostic target data obtained by rotating the second diagnostic target data such that the long side of the second recording medium is identical in direction to the long side of the first recording medium.

### BRIEF DESCRIPTION OF THE DRAWINGS

A more complete appreciation of the disclosure and many of the attendant advantages and features thereof can be readily obtained and understood from the following detailed description with reference to the accompanying drawings, wherein:

FIG. 1 is an illustration for describing an exemplary general arrangement of an image diagnostic system;

FIG. 2 is a diagram illustrating each exemplary internal configuration of an image forming apparatus and an information processing apparatus according to an embodiment;

FIG. 3 is a flowchart for describing an exemplary operation of the image diagnostic system according to an embodiment;

FIG. 4 is a flowchart for describing an exemplary operation of abnormality detection for and factor determination for diagnostic target data;

FIG. 5 is an illustration for describing the procedure of reading test charts according to an embodiment;

FIG. 6 is an illustration of a specific example of pieces of image data in, for example, binarization processing in FIG. 4;

FIG. 7 is an illustration for describing a specific example in judgement of abnormality agreement from the location and orientation of each abnormal area;

FIG. 8 is an illustration of an example of pieces of image data in occurrence of abnormality in printing;

FIG. 9 is an illustration of an example of pieces of image data including test charts of FIG. 8 read (absence of abnormality in reading);

FIG. 10 is an illustration for describing an example of abnormality isolation determination between the pieces of image data of FIG. 9;

FIG. 11 is an illustration of an example of pieces of image data including the test charts of FIG. 8 read (presence of abnormality in reading);

FIG. 12 is an illustration for describing an example of abnormality isolation determination between the pieces of image data of FIG. 11;

FIG. 13 is an illustration for describing the function of notifying a user of a

FIG. 14 is an illustration for describing that an image formation system can be covered entirely with a plurality of test charts.

The accompanying drawings are intended to depict embodiments of the present disclosure and should not be interpreted to limit the scope thereof. The accompanying drawings are not to be considered as drawn to scale unless explicitly noted.

### DETAILED DESCRIPTION

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise.

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Hereinafter, embodiments will be described with reference to the drawings. For clarity of the description, omission and simplification are made appropriately in description and drawings hereinafter. In the drawings, constituent elements having the same configurations or functions and the corresponding parts are denoted by the same reference signs, and the description thereof is omitted.

In a configuration which enables isolation between an abnormality due to a printer factor and an abnormality due to a scanner factor for a technology of output of an image onto a recording medium from a printer (also referred to as “image forming device”) of an image forming apparatus, acquisition of the scanned image by a scanner (also referred to as “image reading device”) of the image forming apparatus, and detection of abnormality to facilitate specification of a factor of an “image abnormality,” embodiments of the present disclosure have features below.

A test pattern is printed on each of a plurality of recording media different in size and orientation to create a test chart. Then, an orientation of an image printed on the test chart is changed and the image is read to determine whether the cause of an abnormal image is present in a scanner or a printer. As the plurality of recording media different in size and orientation, for example, the test pattern is printed on a recording medium scannable by changing an orientation. In addition, printing of a maximum scanner-scannable size enables image diagnosis in a range of a wider image forming region.

In an image diagnostic system according to one aspect of the present disclosure, the following processes are executed, for example.

An image forming process in which the image forming device forms the test pattern on each of a first recording medium and a second recording medium smaller in size than the first recording medium with the first recording medium having a long side in agreement with a long side of the second recording medium in a conveying direction.

A diagnostic target data generating process in which the image reading device generates first diagnostic target data read from the first recording medium on which the test pattern is formed and generates second diagnostic target data read from the second recording medium on which the test pattern is formed and which is rotated such that the long side of the second recording medium is different in direction from the long side of the first recording medium.

An acquisition process in which an acquisition device acquires the first diagnostic target data and the second diagnostic target data.

A diagnosis process in which a diagnostic unit detects an abnormal area and diagnoses an abnormality factor, with the test pattern, the first diagnostic target data, the second diagnostic target data, and third diagnostic target data obtained by rotating the second diagnostic target data such that the long side of the second recording medium is identical in direction to the long side of the first recording medium.

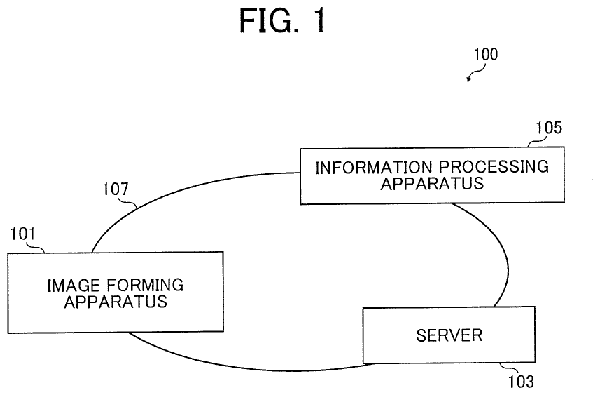

Hereinafter, an embodiment of the present disclosure will be described in detail with reference to the drawings. FIG. 1 is an illustration for describing an exemplary general arrangement of an image diagnostic system (also referred to as “abnormal image diagnostic system”). An image diagnostic system 100 includes, for example, an image forming apparatus 101, a server 103, and an information processing apparatus 105, and respective apparatuses are connected through a communication line (communication means) 107. Here, as an example of the arrangement of the image diagnostic system 100, it is considered that the exchange between the image forming apparatus 101 and the server 103 connected through a network is performed.

The image forming apparatus 101 includes at least an image forming device (also referred to as “printer”) and an image reading device (also referred to as “scanner”). The image forming apparatus 101 serves as, for example, a multifunction printer (MFP). The server 103 has the function of the information processing apparatus 105 and the function of controlling the entire image diagnostic system 100. In addition, the server 103 is capable of functioning as an information processing apparatus that makes data communication with information processing apparatuses inside and outside the image diagnostic system 100. For example, implementation of an image diagnosis function in the server 103 also enables the server 103 to achieve as a remote diagnostic system. The information processing apparatus 105 serves as a general computer and executes various types of arithmetic processing, for example. The communication line (communication means) 107 enables information transmission and reception among the image forming apparatus 101, the server 103, and the information processing apparatus 105. Examples of the communication line (communication means) 107 include a local area network (LAN), the Internet, Bluetooth (registered trademark), and a universal serial bus (USB). The communication line 107 may be either wired or wireless.

In the image diagnostic system 100, the image forming apparatus 101 prints a test pattern on a recording medium to create a test chart, and generates, as diagnostic target data, image data obtained by reading (scanning) the test pattern printed on the test chart. The image forming apparatus 101 transmits the diagnostic target data scanned by the image reading device to the server 103 via the communication line (communication means) 107. When receiving the diagnostic target data, the server 103 starts image diagnosis (abnormal image diagnosis). The server 103 transmits the image diagnostic result to the image forming apparatus 101. At this time, the start of image diagnosis may be instructed by the image forming apparatus 101 to the server 103 or from the server 103 to the image forming apparatus 101.

In addition, the image diagnostic system may be configured as below. The information processing apparatus 105 is also capable of issuing, for example, a test-chart printing instruction or an image-data scanning instruction to the image forming apparatus 101, and an uploading instruction to the server 103. When the information processing apparatus 105 instructs image diagnosis, the server 103 may transmit the image diagnostic result to the information processing apparatus 105.

The server 103 serves as an information processing apparatus that makes data communication with the internal and external information processing apparatuses 105. For example, implementation of an image diagnosis function in the server 103 also enables the server 103 to achieve as a remote diagnostic system. The image diagnostic system may be capable of exchanging information in the image diagnostic system in such various forms.

Furthermore, the image diagnostic system may have a form such that the functions of the image forming apparatus 101, the server 103, and the information processing apparatus 105 are built in one apparatus. When the function of the image diagnostic system is achieved in one apparatus, the image diagnostic system enables image diagnosis even if the image diagnostic system is not connected though the communication line (communication means) 107 and not connected to an external network. For example, the image forming apparatus 101 may include an image diagnosis function. For example, the image forming apparatus 101 may include, in the apparatus, a function of acquiring diagnostic target data obtained by reading a test chart and diagnosing the diagnostic target data (for example, as part of a control unit).

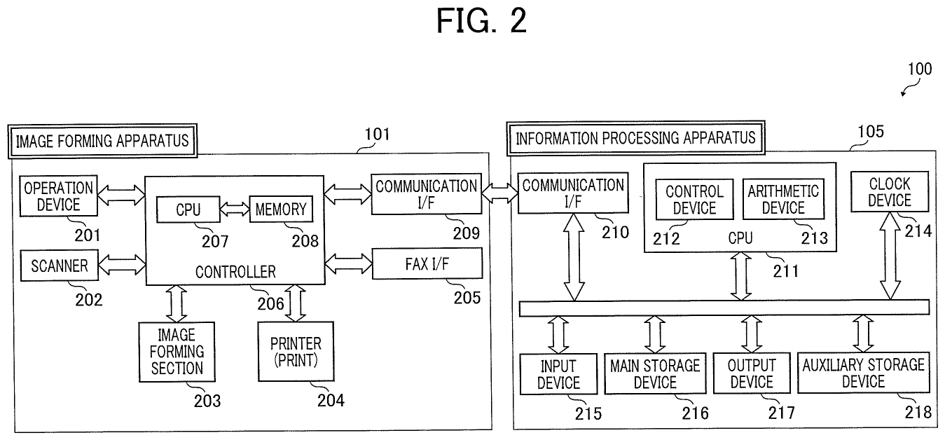

Next, each exemplary internal configuration of the image forming apparatus 101 and the information processing apparatus 105 will be described. In an embodiment of the present disclosure, the server 103 includes at least a configuration similar to the configuration of the information processing apparatus 105. FIG. 2 is a diagram illustrating each exemplary internal configuration of the image forming apparatus 101 and the information processing apparatus 105. The image forming apparatus 101 includes an operation device 201, a scanner 202, an image forming section 203, a printer 204, a facsimile interface (Fax I/F) 205, a controller 206 including a central processing unit (CPU) 207 and a memory 208, and a communication I/F 209.

An operation device 201 serves as a user I/F of the image forming apparatus 101. Assuming that this part is a touch-panel type smart user interface (UI) and the system is used with the touch panel, the operation device 201 is considered as an alternative to the information processing apparatus.

The scanner 202 reads any image data and sends the read image data to the controller 206. The image forming section 203 generates each image (for example, test pattern). The printer 204 outputs the image generated by the image forming section 203 to any recording medium. For example, the printer 204 prints the test pattern on sheets different in size.

In the present embodiment, the scanner 202 functions as an image reading device that reads an image formed on a recording medium having any size. The image forming section 203 and the printer 204 each function as an image forming device that forms the image on the recording medium having any size conveyed in a conveying direction.

The controller 206 controls the entire image forming apparatus 101. The controller 206 includes at least a central processing unit (CPU) 207 and the memory 208. The CPU 207 and the memory 208 are connected with an internal I/F. The CPU 207 reads and executes a control program or the like stored in the memory 208. The memory 208 includes a volatile storage such as a random access memory (RAM) and a nonvolatile storage such as a read only memory (ROM) and a hard disk drive (HD). The memory 208 stores, for example, print information of the test chart (for example, size, orientation, and image data of the test pattern).

The communication I/F 209 is disposed on the image forming apparatus 101 side and exchanges (transmits and receives) data with the information processing apparatus 105. The Fax I/F 205 exchanges (transmits/receives) data with a facsimile.

Next, the information processing apparatus 105 will be described. The information processing apparatus 105 includes a communication I/F 210, a CPU 211, a clock device 214, an input device 215, a main storage device 216, an output device 217, and an auxiliary storage device 218.

The communication I/F 210 is disposed on the information processing apparatus 105 side, and exchanges (transmits/receives) data with the image forming apparatus 101. The communication I/F 210 functions as an acquisition device. The CPU 211 cooperates with the main storage device 216, the output device 217, and programs stored in the auxiliary storage device 218 to function as a device that inputs information into the main storage device 216, the output device 217, and the auxiliary storage device 218. A control device 212 controls an operation according to a clock timing, and an arithmetic device 213 performs arithmetic processing on digital data. In the present embodiment, the CPU 211 as processing circuitry executes a program (image diagnostic program) that achieves a diagnostic unit.

The clock device 214 generates a clock. The input device 215 serves as a piece of equipment with which various types of data are input, and as the input device 215, a keyboard, a mouse, a touch panel, or a charge coupled device (CCD) camera is used.

The main storage device 216 stores and retains a program and data, and reads the retained data to a register in accordance with an instruction from the control device 212. Here, for example, the main storage device 216 retains and reads a program of the image diagnostic system, and image data and condition data received from the image forming apparatus 101. The condition data includes, for example, information on the number of print sheets, a component, and a consumable item (e.g., toner cartridge) of the image forming apparatus 101. The output device 217 outputs an arithmetic result or the like (e.g., display or audio output). The auxiliary storage device 218 is auxiliary to the storage capacity of the main storage device 216.

Next, an example of the operation of the image diagnostic system will be described. An embodiment of the present disclosure will be described with an exemplary configuration in which the image forming apparatus 101 includes the image forming device and the image reading device, and the server 103 (or the information processing apparatus 105) includes the acquisition device and the diagnostic unit. In addition, as an example, an A3 size sheet is used as a first recording medium, and an A4 size sheet is used as a second recording medium.

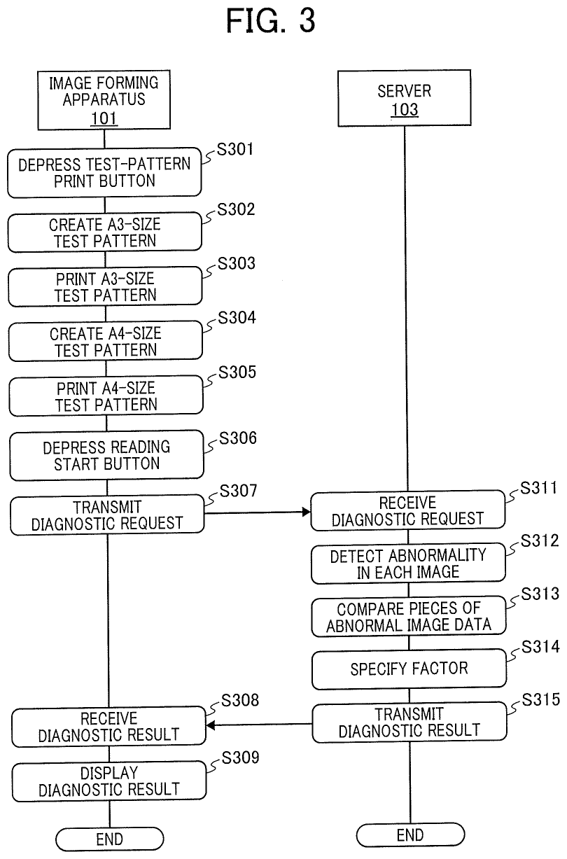

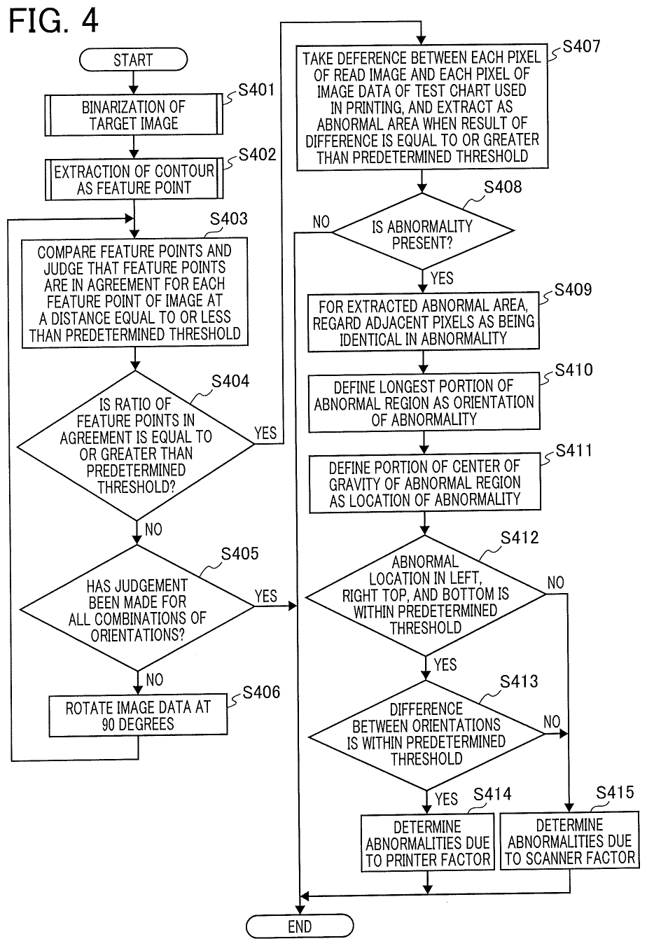

FIG. 3 is a flowchart for describing an exemplary operation of the image diagnostic system according to an embodiment of the present disclosure. FIG. 4 is a flowchart for describing an exemplary operation of detecting abnormality in diagnostic target data to determine a factor. FIGS. 3 and 4 each illustrate an exemplary operation in which image diagnosis is performed between the image forming apparatus 101 and the server 103. In addition, it will be described that the image forming apparatus 101 is capable of reading A3 as the maximum size, and A4 as the size by changing an orientation. In FIG. 3, steps S302 to S305 indicate image forming processes, step S306 indicates an image reading process, step S311 indicates an acquisition process, steps S312 to S314 indicate diagnostic processes, and step S315 indicates a diagnostic-result output process. Details of each process will be described below.

The image forming apparatus 101 starts with a test-pattern print button depressed from the operation device 201 by the user (S301), prints respective test patterns on a plurality of recording media (for example, sheets) different in size, and creates (outputs) test charts (S302 to S305).

Specifically, the image forming section 203 reads test-pattern image data from the memory 208, creates an A3-size test pattern, and stores the created A3-size test pattern into the memory 208 (S302). The printer 204 reads the created A3-size test pattern from the memory 208, prints the created A3-size test pattern on an A3 size sheet (S303), and creates an A3-size test chart with the test pattern printed.

Next, the image forming section 203 reads test-pattern image data from the memory 208, creates an A4-size test pattern, and stores the created A4-size test pattern into the memory 208 (S304). The printer 204 reads the created A4-size test pattern from the memory 208, prints the created A4-size test pattern on an A4-size sheet (S305), and creates an A4-size test chart with the test pattern printed. The printer 204 makes agreement between the respective long sides of the A3 size sheet and the A4 size sheet in the conveying direction to print the sheets.

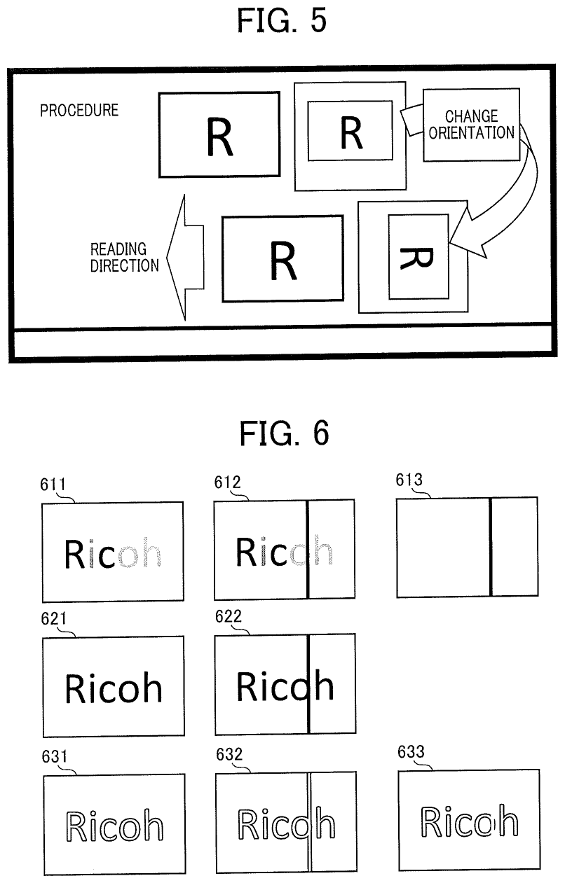

Next, in order to read the test charts with the test patterns printed on the plurality of recording media, a user depresses a reading start button from the operation device 201 (S306). For example, the user disposes the test charts according to the procedure illustrated in FIG. 5, and causes the scanner 202 of the image forming apparatus 101 to read the test charts. In FIG. 5, the upper portion illustrates a state in printing, and the lower portion illustrates a state in reading. As illustrated in the upper portion, when the test charts with the test patterns printed on the two sheets in different size are output, it is prompted to change the orientation of the test chart on the smaller sheet and start reading.

In the image forming apparatus 101, the scanner 202 sends image data obtained by reading the test charts, to the controller 206. In a case where the orientation of the document (sheet) has not been changed, the controller 206 notifies again the user to change the reading orientation, via the operation device 201. As a method of deciding whether the orientation has been changed, for example, the orientation can be detected with a sensor that detects a document size or a method of sensing the orientation of a test pattern of image data as a result of reading. For example, when no perpendicular relationship exists between the respective long sides of the A3 sheet and the A4 sheet, the controller 206 notifies again the user to read the test patterns.

The controller 206 generates image data obtained by the scanner 202 reading the A3-size test chart as first diagnostic target data, and image data obtained by the scanner 202 reading the A4-size test chart as second diagnostic target data. In the following description, when no discrimination is required between the first diagnostic target data and the second diagnostic target data, the first diagnostic target data and the second diagnostic target data are both appropriately referred to as “diagnostic target data.” Here, the second diagnostic target data is image data obtained by rotating the A4-size test chart such that the long side of the A4 size sheet (second recording medium) is different in direction from the long side of the A3 size sheet (for example, perpendicular relationship) and reading the rotated A4-size test chart.

The controller 206 of the image forming apparatus 101 transmits a diagnostic request to the server 103 together with the read diagnostic target data, via the communication I/F 209 (S307).

The server 103 receives the diagnostic request from the image forming apparatus 101 via the communication I/F 210 and starts image diagnosis (S311). For example, the CPU 211 reads the image diagnostic program or the like stored in the main storage device 216 and executes a command group of the program, so that an image diagnosis function described below can be achieved. The CPU 211 detects an abnormal area in the image for each of the A3-size diagnostic target data and the A4-size diagnostic target data (S312). Here, data indicating abnormality in the image is abnormal image data.

The CPU 211 compares respective pieces of abnormal image data detected from the pieces of diagnostic target data different in size (S313). At this time, the orientation and location in printing of the abnormal image data are restored. The restoration method will be described later with reference to FIG. 4. In addition, the CPU 211 generates third diagnostic target data obtained by restoring the orientation of the second diagnostic target data. The third diagnostic target data is image data obtained in a manner that the second diagnostic target data obtained by rotating the A4-size test chart and reading the A4-size test chart is rotated such that the long side of the A4 size sheet is identical in direction to the long side of the A3 size sheet, and by restoring the rotated test chart in the orientation for printing.

When the abnormal image data agrees in location and orientation of abnormality with the restored image data, the CPU 211 judges as an image abnormality due to printer abnormality, and when no agreement is made, the CPU 211 judges as an abnormal image due to scanner abnormality (S314). The determination whether the abnormalities are in agreement will be described later with reference to FIG. 4.

The server 103 transmits the diagnostic result to the image forming apparatus 101, via the communication I/F 210 (S315). The image forming apparatus 101 receives the diagnostic result from the server 103, via the communication I/F 209 (S308). The image forming apparatus 101 displays the diagnostic result (S309). Note that, in the exemplary operation of FIG. 3, the image forming apparatus 101 displays the diagnostic result in step S309. However, the server 103 or the information processing apparatus 105 may display the diagnostic result.

Next, referring to FIG. 4, details of an exemplary operation of diagnosing the abnormal image (steps S312 to S314 in FIG. 3) will be described. In FIG. 4, steps S401 to S406 are an exemplary operation of specifying the orientation of a test pattern drawn on each read document. Here, the result of contour extraction from image data is used as an example of a way for specifying the orientation; however, a corner, a curve, or the like may be used. In addition, there is a method of embedding a specific pattern in a test pattern in advance.

The CPU 211 binarizes all pixels in the read image data, with a predetermined threshold as a boundary (S401). The predetermined threshold is a changeable parameter. When adjacent pixels have different values in the image data binarized in step S401, the CPU 211 regards a pixel having the larger value as a contour and extracts the pixel as a feature point (S402). However, the method of achieving the processing of obtaining the contour is not limited to the above method. The CPU 211 compares the feature point extracted in step S402 with a feature point extracted in advance from the original test pattern, and judges that the feature points are in agreement, for the location of the pixel indicating each feature point at a distance equal to or less than a predetermined threshold (S403). The predetermined threshold is a changeable parameter.

When the ratio of the feature points that are judged to be in agreement in step S403 is equal to or greater than a predetermined ratio of all feature points, the CPU 211 decides that the read test pattern and the original test pattern are in agreement in orientation (Yes in S404), and the processing makes transition to step S407. The predetermined ratio is a changeable parameter.

When it is judged in step S404 that the orientations are in disagreement (No in S404), the CPU 211 rotates either the read test pattern or the original test pattern by 90 degrees (S406), and the processing is repeated from steps S401 to S406. As an exception, when the agreement ratio of feature points in all combinations of the orientations does not exceed the predetermined threshold (Yes in S405), the processing ends.

When it is judged that the orientations are in agreement (Yes in S404), the CPU 211 extracts an abnormal area from the read test chart in step S407. For example, as an abnormality extraction method, a difference with the original test chart is taken and an area having a difference equal to or larger than a predetermined threshold is extracted as an abnormal pixel.

As the above method of taking the difference between the images, there is a method of taking a difference in intensity value of each RGB channel for each pixel on each coordinate for all pixels of the original test chart and all pixels of the test chart. Another achievement method may be used. In addition, as the above method of determination with the threshold, there is a method in which an intensity difference threshold is provided for a difference in intensity value of each RGB channel for each pixel, the number of pixels exceeding the intensity difference threshold is counted, a difference pixel-number threshold is further provided for the counted number, and judgement as abnormality is made when the counted number exceeds the difference pixel-number threshold. Another achievement method may be used.

As a result of step S407, when abnormality is extracted (Yes in S408), the CPU 211 continues diagnosis. When no abnormality is present, the diagnosis flow ends (No in S408). When abnormality is extracted (Yes in S408), as pre-processing of specifying the orientation and center of gravity of the abnormality, for each pixel extracted as having abnormality in step S407, the CPU 211 classifies, among adjacent abnormalities at sides or vertexes of pixels, pixels each having a color or a density within a predetermined threshold as having an identical abnormality (S409). The color and density of the pixel are used in order to perform processing of avoiding erroneous determination as an identical abnormality, mainly even when abnormalities overlap. As a method of avoiding the erroneous determination, a method is conceivable in which the shape of each abnormality is registered in advance and determination as an identical abnormality is made when a similar point in shape is present.

Next, for the abnormality regarded as identical in step S409, the CPU 211 defines the orientation of the longest portion of the abnormal region as the orientation of the abnormality (S410). The method of specifying the orientation is not limited to the above method, and the orientation may be defined on the basis of a characteristic portion such as a corner or a curve. For the abnormality regarded as identical in step S409, the CPU 211 defines a portion of the center of gravity of the abnormal region as the location of the abnormality (S411). Step S411 is also performed for specifying the location of abnormality. Thus, the location may be defined from a characteristic shape such as an abnormal contour or an abnormal vertex, instead of the center of gravity.

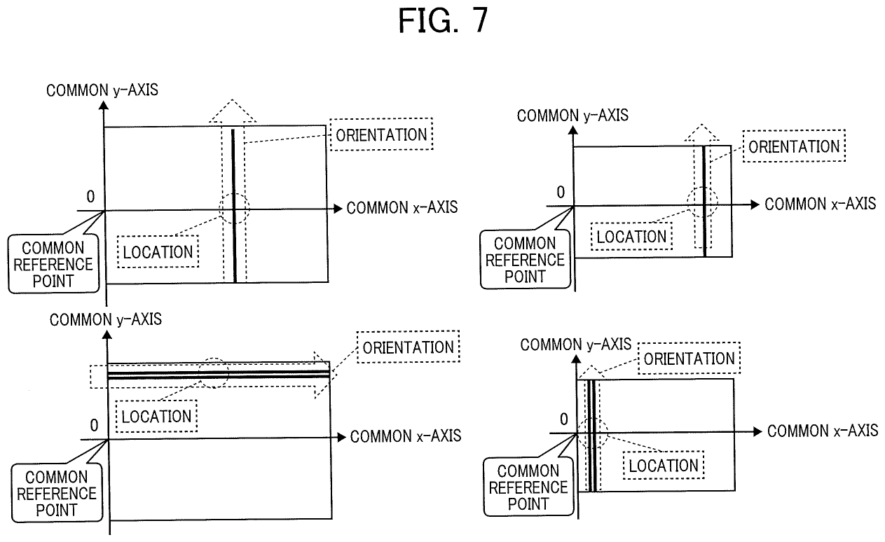

In steps S412 to S413, the abnormal areas extracted from the read test charts different in size and orientation are compared to judge whether the abnormalities are due to an identical factor. For each abnormalities extracted from the read test charts different in size and orientation, when a location difference in left, right, top, and bottom is within a predetermined threshold (Yes in S412), the CPU 211 judges that the abnormality is present at an identical location, and the processing makes transition to step S413. In contrast, when the location difference exceeds the predetermined threshold (No in S412), the processing makes transition to step S415. A method of obtaining the location difference will be described later with reference to FIG. 7.

When decision is made whether the abnormalities are in agreement in location between the pieces of image data different in size, the decision is made whether the abnormalities are in agreement in location in a region where the abnormalities are likely to overlap, namely, the abnormality in the larger-size region agrees in location with the abnormality in the smaller-size region. The CPU 211 compares the abnormalities extracted from the read test charts different in size and orientation, and when the orientations of the abnormalities are within a predetermined threshold (Yes in S413), the processing makes transition to step S414. When the orientations of the abnormalities exceed the predetermined threshold (No in S413), the processing makes transition to step S415.

When the CPU 211 determines in steps S412 and S413 that the abnormalities are in agreement in location and orientation, the CPU 211 determines abnormalities due to a printer factor (S414). When the CPU 211 determines in steps S412 and S413 that the abnormalities are in disagreement either in location or in orientation, the CPU 211 determines the abnormalities due to a scanner factor (S415).

Next, with specific examples, there will be described the binarization processing (e.g., steps S401 to S403, and S407) described in FIG. 4 and the processing of determining whether the abnormalities are in agreement or not (e.g., steps S409 to S413).

FIG. 6 is an illustration of a specific example of pieces of image data in, for example, the binarization processing in FIG. 4. In FIG. 6, the original image data of a test pattern and pieces of image data processed from the original image data are illustrated in the left column, image data in printing and reading the original image data of the test pattern and image data processed from the printed and read image data are illustrated in the central column, and pieces of image data for describing the result of processing after the pieces of image data have been processed are illustrated in the right column.

Image data 611 is an example of the original image data used as image data in printing the test pattern. Image data 612 is an example of read image data in printing and reading the test pattern and serves as diagnostic target data. Image data 613 is an example in which a difference between the image data 611 and the image data 612 is taken to extract an abnormal image in step S407 (image data after abnormal extraction).

Image data 621 is an example of the original image data obtained by performing the binarization processing on the image data 611 in step S401. Image data 622 is an example of read image data obtained by performing the binarization processing on the image data 612 in step S401.

Image data 631 is an example of the original image data obtained by extracting the contour of the image data 621 in step S402. Image data 632 is an example of read image data obtained by extracting the contour of the image data 622 in step S402. Image data 633 is an example of the result obtained by comparing the contour-extracted images (image data 631 and image data 632) and extracting points in agreement in step S403.

FIG. 7 is an illustration for describing a specific example in judgement of abnormality agreement from the location and orientation of each abnormal area. FIG. 7 illustrates the specific example in which for each piece of the image data different in size, the location and orientation of the abnormality are specified and judgement is made whether the location and orientation are in agreement in steps S409 and S410. In FIG. 7, the upper portion illustrates an example of each piece of image data in occurrence of abnormality due to a printer factor, and the lower portion illustrates an example of each piece of image data in occurrence of abnormality due to a scan factor. The left side illustrates each piece of A3-size image data and the right side illustrates each piece of A4-size image data.

First, in order to compare the locations of abnormalities on the pieces of image data different in size, respective reference points on common coordinates are defined. The reference point on the common y-axis depends on which portion of the image formation system a test chart is image-formed in printing. The example of FIG. 7 illustrates a case where in image formation for each test pattern different in size, the image is formed at a symmetric distance in a main scanning direction from a central portion of an image forming component, and a location where the image data is divided into equal parts vertically is defined as the reference point on the common y-axis. The reference point is uniquely determined by a machine configuration and the size of a printed sheet. The reference point on the common x-axis may be located anywhere; however, in the present embodiment, the left end of the image data of each test chart is defined as the reference point on the common x-axis. A portion where the reference point on the common x-axis and the reference point on the common y-axis intersect is defined as a common reference point, and a location from the common reference point is calculated for abnormalities extracted from the pieces of image data.

For the abnormalities extracted from the pieces of image data, a difference in vertical distance and a difference in horizontal distance in location from the common reference point are each extracted, and when each distance is equal to or less than a predetermined threshold, the abnormalities are regarded as abnormalities present at an identical location. However, a method of judging, for the abnormalities in the pieces of image data, whether the abnormalities are present at an identical location is not limited to the above method. The upper portion of FIG. 7 is the example in which it is determined that the abnormal images are due to the printer factor because the abnormalities are in agreement in orientation and location. The lower portion of FIG. 7 is the example in which it is determined that the abnormal images are due to the scanner factor because the abnormalities are in disagreement in orientation and location.

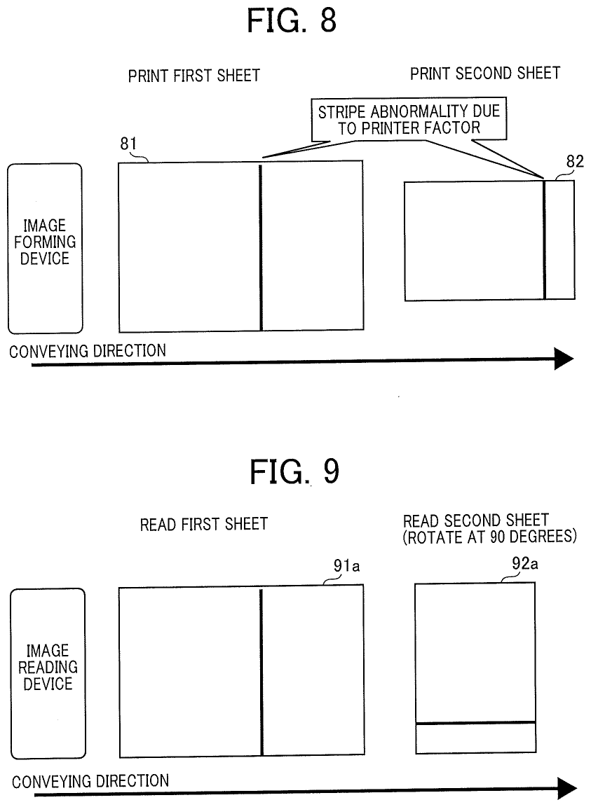

Next, specific examples of the diagnostic target data in each pieces of the above processing will be described. Here, the description of the specific examples will be made with an abnormal portion having occurred in printing or reading illustrated as image data read from each test chart and the test pattern omitted. FIG. 8 is an illustration of an example of pieces of image data in occurrence of abnormality in printing. The printer 204 of the image forming apparatus 101 prints a test pattern on an A3 size sheet as a first sheet and outputs a test chart 81, and prints a test pattern on an A4 size sheet as a second sheet and outputs a test chart 82, for example. At this time, the printer 204 makes agreement between the respective long sides of the sheets in the conveying direction to print the sheets. FIG. 8 illustrates an example of occurrence of abnormalities due to a printer factor (hereinafter also appropriately referred to as “printer-factor abnormality”) and occurrence of a stripe along the short side direction of each of the test charts 81 and 82. Note that, as described above, in FIG. 8, the test patterns are omitted and the abnormalities having occurred in printing are illustrated. In FIGS. 9 to 12 referred to hereinafter, test patterns are omitted and abnormalities having occurred in printing are illustrated similarly to FIG. 8.

FIG. 9 is an illustration of an example of image data including the test charts of FIG. 8 (absence of abnormality in reading). Each piece of image data illustrated in FIG. 9 is an example of image data in occurrence of abnormality due to a printer factor and in absence of abnormality due to a scanner factor (hereinafter also appropriately referred to as “scanner-factor abnormality” or “reading abnormality”).

The scanner 202 of the image forming apparatus 101 reads the test chart 81 printed on the A3 size sheet as a first sheet, in a direction identical to the printed direction of the test chart 81, and generates image data 91a. Furthermore, the scanner 202 reads the test chart 82 printed on the A4 size sheet, in a direction in which the printed direction of the test chart 82 is rotated by 90 degrees, and generates image data 92a. Thus, the long side of the A3 size sheet agrees with the conveying direction, and the long side of the A4 size sheet has a perpendicular relationship with the conveying direction. The image data 91a is first diagnostic target data, and the image data 92a is second diagnostic target data. When the test charts 81 and 82 are read in such a manner, as illustrated in FIG. 9, stripes having occurred as the abnormalities due to the printer factor illustrated in FIG. 8 are present in different directions between the A3 size sheet and the A4 size sheet.

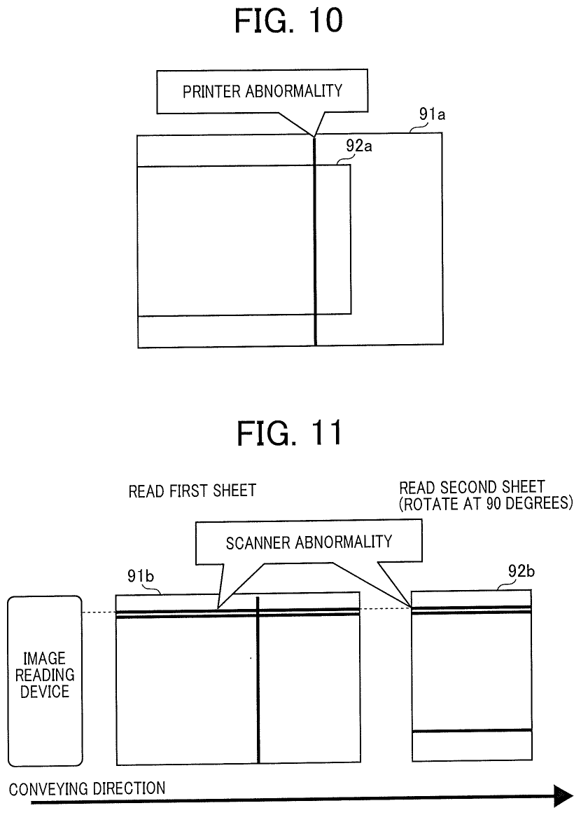

FIG. 10 is an illustration for describing an example of abnormality isolation determination of the image data of FIG. 9. FIG. 10 is an illustration of a situation in which the image data 91a of the A3 size sheet and the image data 92a of the A4 size sheet read after the printing of the test patterns are corrected in the orientation for printing of each sheet, and the sheets are superimposed and compared to make determination. In FIG. 10, in the two pieces of scanned image data 91a and 92a, the abnormalities indicated by a solid line are in agreement in location and direction. Thus, the abnormalities can be judged as abnormalities due to the printer abnormality factor.

FIG. 11 is an illustration of an example of pieces of image data including the test charts of FIG. 8 read (presence of abnormality in reading). Each piece of image data illustrated in FIG. 11 is an example of image data in occurrence of abnormality due to the printer factor and in further occurrence of abnormality due to a scanner factor. The scanner 202 of the image forming apparatus 101 indicates image data 91b and image data 92b obtained as a result of reading first and second sheets similarly to FIG. 9. In FIG. 11, dotted lines are explanatory auxiliary lines indicating locations where abnormalities due to an identical factor appear on the left and right images. In FIG. 11, on the A3-size image data 91b and the A4-size image data 92b, two solid lines associated with the dotted lines are indicated as reading abnormalities.

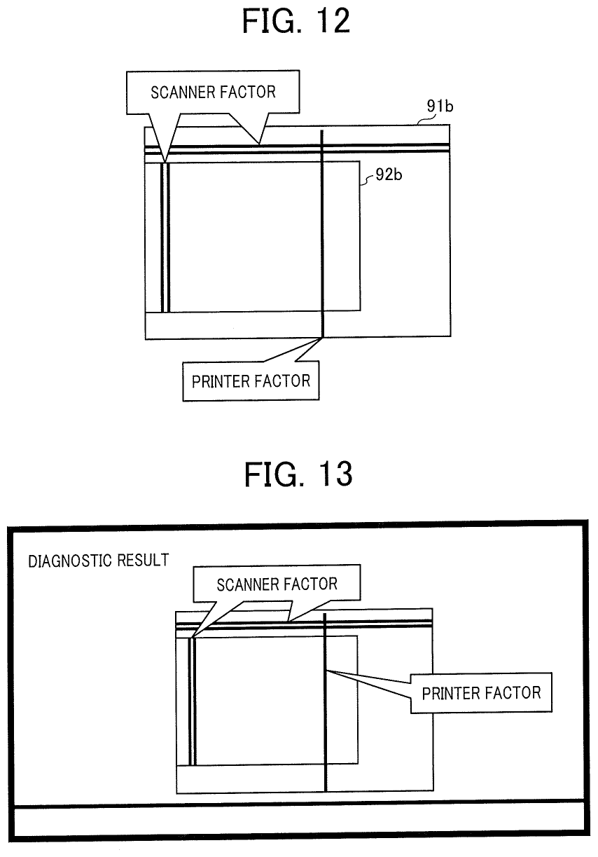

FIG. 12 is an illustration for describing an example of abnormality isolation determination for the pieces of image data of FIG. 11. In FIG. 12, similarly to FIG. 10, image data 91b and image data 92b obtained by reading the test charts 81 and 82 (FIG. 8) of the two types of sheets are corrected in the orientation for printing of each sheet, and the sheets are superimposed and compared to make determination. In FIG. 12, in the two pieces of scanned image data 91b and 92b, abnormalities indicated by a single solid line are in agreement in location and direction. Thus, the abnormalities can be judged as abnormalities due to the printer abnormality factor. In contrast, in the left and right images, abnormalities indicated by two solid lines are in disagreement in location and direction for the reading. Thus, the abnormalities can be judged as abnormalities due to the scanner abnormality factor.

FIG. 13 is an illustration for describing a function of notifying a user of the diagnostic result. As an example of the function of notifying the diagnostic result, a display screen is displayed with the operation panel of the image forming apparatus. However, the function is not limited to the above example. As a way of notifying the diagnostic result, another way of notification such as sound may be conceivable.

In the example of the above-described embodiment, the isolation between the scanner factor and the printer factor (scanner and plotter) are performed and the determination flow ends. However, in some embodiments, further diagnostic processing of analyzing and isolating between detailed factors may be subsequently performed as needed. For example, after determination that abnormality is due to a printer factor in step S414, and the factor may be further narrowed down using a judgement algorithm for isolating between a developing-device abnormality factor and a charging-device abnormality factor.

For example, an image developed without exposure and an image on a recording material developed with exposure and printed may be read to diagnose whether the images are striped images due to any of the charging-device factor or the developing-device factor.

Note that, in FIGS. 8 to 13, as an example, the abnormalities due to a printer factor and the abnormalities due to a scanner factor are described with the single solid line and the two solid lines, respectively. However, abnormal phenomena and determinable abnormalities are not limited to the abnormalities.

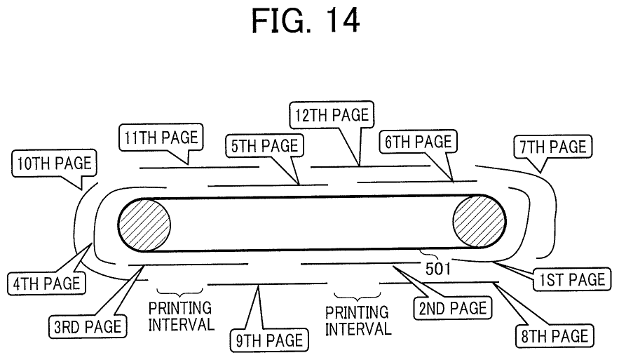

Next, a case where a plurality of test charts is used in order to cover entirely the image formation system of the printer 204 will be described. FIG. 14 is an illustration for describing that the image formation system can be covered entirely with the plurality of test charts. An example of FIG. 14 illustrates a case where the entire region of a surface of a transfer belt can be covered with 12 sheets.

A longest component in the sub-scanning direction among the components included in the image formation system built in the image forming apparatus 101 is assumed to be a transfer belt 501. However, depending on the components included in the image formation system of the image forming apparatus 101, the other component may be the longest. In general, the long side of a maximum readable size has a length that does not exceed the length of the components included in the image formation system. Thus, covering the image formation system with a single test chart is difficult. Therefore, the plurality of test charts is printed in order to cover the image formation system. For example, the plurality of test charts may be created by printing respective identical test patterns on a plurality of sheets. In addition, a sheet in a maximum readable size may be used. Each printing interval, however, may be longer. In such a case, printing of each test chart so as to fill a clearance enables covering entirely the image formation system.

Here, assuming that the image formation system has an outer circumferential length of X, a sheet length of S, and an inter-sheet length of D, the number N of sheets required for covering the image formation system is represented by the following expression.

$$N = ⌊ \frac{X}{S + D} ⌋ * ⌈ ( \frac{D}{S} ) + 1 ⌉ \qquad [ Mathematical Formula 1 ]$$

wherein
[A] the maximum integer equal to or less than A
[A] the maximum integer equal to or greater than A

The diagnostic unit diagnoses whether an abnormality is present in a plurality of pieces of diagnostic target data obtained by reading the plurality of test charts. For example, the diagnostic unit may compare a plurality of pieces of first diagnostic target data obtained by reading a plurality of A3-size test charts to detect whether an abnormality is present in a piece of image data, and then the diagnostic unit may compare the piece of first diagnostic target data having the abnormality detected, with second diagnostic target data and third diagnostic target data, to determine a factor of the abnormality. Printing of the plurality of sheets enables covering the inspection of an abnormal image at an image forming region.

### Other Embodiments

In the above-described embodiments, the recording device that records a test pattern may be a device that acquires a test pattern in advance, records and retains the test pattern (process in which the test pattern is retained), in the image forming apparatus 101, the server 103, or the information processing apparatus 105. Alternatively, the recording device may be a device that temporarily records a test pattern received from the outside to retain the test pattern (for example, the test pattern is received before starting diagnosis and retained until after the diagnosis ends). In addition, in the retaining process (retaining procedure) in which the test pattern is retained, the test pattern may be recorded and retained at least temporarily in a recording device in an apparatus (for example, during image diagnosis).

In the above-described embodiments, the image diagnostic system has been described in which the server 103 diagnoses the first diagnostic target data and the second diagnostic target data read by the image forming apparatus 101. The image forming apparatus 101, however, may include the acquisition device and the diagnostic unit described above. For example, in the exemplary configuration of the image forming apparatus 101 in FIG. 2, the controller 206 may be configured such that the CPU 207 executes a command group of a program that achieves the acquisition device and the diagnostic unit. For example, the scanner 202 may record read diagnostic target data in the memory 208, and the controller 206 may be configured such that the acquisition device reads the diagnostic target data from the memory 208 to pass the diagnostic target data to the diagnostic unit.

In addition, in the image diagnostic system, when the start of image diagnosis is requested from a remote place, for example, the request may be made as described below. When the information processing apparatus 105 (or the server 103) receives the request for starting the image diagnosis from the input device 215, the communication I/F 210 that functions as an acquisition device notifies the image forming apparatus 101 of the request. In response to the notified request, the image forming apparatus 101 generates diagnostic target data (first diagnostic target data and second diagnostic target data), and transmits the diagnostic target data to the information processing apparatus 105 via the communication I/F 209.

As described above, in an embodiment of the present disclosure, sheets different in size, such as a sheet in a maximum scannable size or less (for example, A3) and a sheet having a long side of a maximum scannable size or less (for example, A4) are used to create two test charts each including a test pattern printed. In such a manner, creating of the test chart with the maximum scannable size (for example, A3) printed enables diagnosis of a wider range of abnormalities.

In addition, in the reading of the test charts, (1) first, the entire region of the test chart in the maximum size (A3 in this case) is scanned and stored as the first diagnostic target data. (2) Next, the test chart (A4 in this case) having size having the readable long side is scanned by switching the main scanning direction to the sub-scanning direction in the printing, and the test chart is stored as the second diagnostic target data. In such a manner, printing and reading of a test chart of a size having a changeable orientation enables discrimination whether an abnormality results from a printer factor or a scanner factor.

Furthermore, in the image diagnosis, the stored first and second diagnostic target data are compared, and when an abnormality identical in type appears at each location, it is determined that the abnormality due to the scanner factor, and when an abnormality identical in type does not appear at each location, it is determined that the abnormality is due to the printer factor. In such a manner, accuracy of determining a factor resulting in occurrence of an abnormal image can be improved. In addition, an abnormality in a wider image forming region can be diagnosed.

The embodiments of the present disclosure can provide advantageous effects in the following cases, for example. In recent years, with improvement in performance of electrophotographic apparatuses, apparatuses that have achieved image quality corresponding to image quality of printing machines have appeared. In order to operate similarly to a printing machine, maintaining high image quality is required. However, use of a printing device for a long time may deteriorate the printing device, so that an abnormal image quality may occur in an image output from the printing device. When an “abnormal image” occurs due to such deterioration, in general, the user who has noticed the abnormality by looking at the image contacts a customer engineer, and the customer engineer visits the installation site of the printing device to deal with the abnormality.

In such a case, the user is difficult to express the state of the abnormal image due to deterioration or the like in words. For example, even in a case where “nonuniformity is present”, specification of the cause has been difficult without understanding detailed information such as direction, frequency, or cycle in occurrence of the nonuniformity. Thus, after pointing out of the abnormal image by the user, the customer engineer has required to go to the installation site of the printer and check directly the image quality abnormality. Then, the customer engineer has predicted a failure area from the confirmed abnormality and specified a related service part. The customer engineer has returned to a service base once, received the service part, and then visited to the user again to deal with the abnormality. Such exchange may have a disadvantage in which not only the customer engineer to move is costly but also downtime is caused due to the inability to use the apparatus until the completion of the handling. As a result, the user productivity has reduced significantly.

With the image diagnostic system of the one embodiment, output of an image from a printing device, acquisition of the scanned image, and detection of an abnormality can facilitate specification of an “abnormal image.” In addition, the diagnostic imaging system has the function of requesting execution of image diagnosis to the printer device from a remote place (for example, remote information processing apparatus) to enable determining a factor of an image abnormality. Thus, a customer engineer can prepare for maintenance and can reduce the frequency of visit. As a result, the above described disadvantage can be solved and the cost can be reduced.

The above-described embodiments are illustrative and do not limit the present disclosure. Thus, numerous additional modifications and variations are possible in light of the above teachings. For example, elements and/or features of different illustrative embodiments may be combined with each other and/or substituted for each other within the scope of the present disclosure.

Any one of the above-described operations may be performed in various other ways, for example, in an order different from the one described above.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA), and conventional circuit components arranged to perform the recited functions.

1. A diagnostic apparatus configured to diagnose an image forming device configured to form an image on a recording medium conveyed in a conveying direction and an image reading device configured to read the image formed on the recording medium, the diagnostic apparatus comprising:
a recording device configured to record a test pattern;
an acquisition device configured to acquire first diagnostic target data and second diagnostic target data, the first diagnostic target data and the second diagnostic target data being obtained in a manner that the image forming device forms the test pattern on each of a first recording medium and a second recording medium smaller in size than the first recording medium with the first recording medium having a long side in agreement with a long side of the second recording medium in the conveying direction and the image reading device reads the first recording medium and reads the second recording medium rotated such that the long side of the second recording medium is different in direction from the long side of the first recording medium; and
processing circuitry configured to detect an abnormal area and diagnose an abnormality factor, with the test pattern, the first diagnostic target data, the second diagnostic target data, and third diagnostic target data obtained by rotating the second diagnostic target data such that the long side of the second recording medium is identical in direction to the long side of the first recording medium.

2. The diagnostic apparatus according to claim 1,
wherein, when detecting respective identical abnormal areas in the first diagnostic target data and the second diagnostic target data, the processing circuitry diagnoses that the abnormality factor is present in the image reading device, and when detecting respective identical abnormal areas in the first diagnostic target data and the third diagnostic target data, the processing circuitry diagnoses that the abnormality factor is present in the image forming device.

3. The diagnostic apparatus according to claim 1,
wherein the long side of the second recording medium is identical in length to a short side of the first recording medium.

4. The diagnostic apparatus according to claim 1,
wherein the first recording medium is twice as large as the second recording medium.

5. The diagnostic apparatus according to claim 1,
wherein the first recording medium has a maximum size readable by the image reading device.

6. The diagnostic apparatus according to claim 1,
wherein the acquisition device acquires
a plurality of pieces of the first diagnostic target data obtained by reading the test pattern formed on each of a plurality of first recording media including the first recording medium, and the processing circuitry detects the abnormal area, with the plurality of pieces of the first diagnostic target data.

7. The diagnostic apparatus according to claim 1,
wherein the acquisition device acquires the first diagnostic target data and the second diagnostic target data from an apparatus including the image forming device and the image reading device.

8. The diagnostic apparatus according to claim 1, further comprising:
the image forming device; and
the image reading device,
wherein the acquisition device acquires the first diagnostic target data and the second diagnostic target data read by the image reading device.

9. An image diagnostic method comprising:
retaining a test pattern;
forming, with an image forming device, the test pattern on each of a first recording medium and a second recording medium smaller in size than the first recording medium with the first recording medium having a long side in agreement with a long side of the second recording medium in a conveying direction;
acquiring first diagnostic target data read by an image reading device from the first recording medium on which the test pattern is formed and second diagnostic target data read by the image reading device from the second recording medium on which the test pattern is formed, the second recording medium being rotated such that a long side of the second recording medium is different in direction from a long side of the first recording medium; and
diagnosing an abnormal factor by detecting an abnormal area, with the test pattern, the first diagnostic target data, the second diagnostic target data, and third diagnostic target data obtained by rotating the second diagnostic target data such that the long side of the second recording medium is identical in direction to the long side of the first recording medium.

10. The image diagnostic method according to claim 9,
wherein the diagnosing includes:
diagnosing, when respective identical abnormal areas in the first diagnostic target data and the second diagnostic target data are detected, that the abnormality factor is present in the image reading device; and
diagnosing, when respective identical abnormal areas in the first diagnostic target data and the third diagnostic target data are detected, that the abnormality factor is present in the image forming device.

11. The image diagnostic method according to claim 9,
wherein the long side of the second recording medium is identical in length to a short side of the first recording medium.

12. The image diagnostic method according to claim 9,
wherein the first recording medium is twice as large as the second recording medium.

13. The image diagnostic method according to claim 9,
wherein the first recording medium has a maximum size readable by the image reading device.

14. The image diagnostic method according to claim 9,
wherein the acquiring includes acquiring a plurality of pieces of the first diagnostic target data obtained by reading the test pattern formed on each of a plurality of first recording media including the first recording medium, and
the diagnosing includes detecting the abnormal area with the plurality of pieces of the first diagnostic target data.

15. The image diagnostic method according to claim 9,
wherein the acquiring includes acquiring the first diagnostic target data and the second diagnostic target data from an apparatus including the image forming device and the image reading device.

16. The image diagnostic method according to claim 9,
wherein the acquiring includes acquiring the first diagnostic target data and the second diagnostic target data read by the image reading device.

17. A non-transitory storage medium storing program code for causing a diagnostic apparatus configured to diagnose an image forming device configured to form an image on a recording medium conveyed in a conveying direction and an image reading device configured to read the image formed on the recording medium , to execute:
recording a test pattern;
acquiring first diagnostic target data and second diagnostic target data, the first diagnostic target data and the second diagnostic target data being obtained in a manner that the image forming device forms the test pattern on each of a first recording medium and a second recording medium smaller in size than the first recording medium with the first recording medium having a long side in agreement with a long side of the second recording medium in the conveying direction and the image reading device reads the first recording medium and reads the second recording medium rotated such that the long side of the second recording medium is different in direction from the long side of the first recording medium; and
diagnosing an abnormality factor by detecting an abnormal area with the test pattern, the first diagnostic target data, the second diagnostic target data, and third diagnostic target data obtained by rotating the second diagnostic target data such that the long side of the second recording medium is identical in direction to the long side of the first recording medium.
